(19) United States
(12) Patent Application Publication
(10) Pub. No.: US 2008/0063040 A1
(43) Pub. Date: Mar. 13, 2008

(54) EQUALIZER DEMODULATING A SIGNAL INCLUDING SP SYMBOLS AND AN EQUALIZATION METHOD THEREFOR

(75) Inventor: Hiroji AKAHORI, Tokyo (JP)

Correspondence Address: VOLENTINE & WHITT PLLC, ONE FREEDOM SQUARE, 11951 FREEDOM DRIVE SUITE 1260, RESTON, VA, 20190, US

(73) Assignee: OKI ELECTRIC INDUSTRY CO., LTD., Tokyo (JP)

(21) Appl. No.: 11/853,042

(22) Filed: Sep. 11, 2007

(30) Foreign Application Priority Data
Sep. 13, 2006 (JP) 2006-248605

(51) Int. Cl. H04L 27/01

(52) U.S. Cl. 375/232

(57) ABSTRACT

In an equalizer, an scattered pilot (SP) extractor in a channel estimator extracts an SP symbol from an input signal, an IDFT circuit calculates from the SP a complex gain of each path, and a threshold comparator and a “0” addition circuit extract signals of paths. An FFT circuit Fourier-transforms signals of the paths. A multiplier in an operational equalizer multiplies a complex conjugate signal of a transmission line estimation in the path on which the Fourier-transform was made and the input signal to output the product to the coordinate corrector. A coordinate threshold generator multiplies the transmission line estimation by the complex conjugate signal to generate power of a coordinate threshold to output the power to a window function circuit, which corrects the power value to supply the value to the coordinate corrector. The corrector corrects the amplitude of the modulation coordinate in the product to output the amplitude.

### BACKGROUND OF THE INVENTION

1. Field of the Invention

The present invention relates to an equalizer, and more particularly to an equalizer that uses a scattered pilot (SP) symbol in the demodulation of a digitally modulated signal under the orthogonal frequency division multiplexing (OFDM). The present invention also relates to an equalization method therefor.

2. Description of the Background Art

Conventionally, terrestrial broadcasting services, such as the Integrated Services Digital Broadcasting Television (ISDB-T), uses the OFDM digital modulation. This modulation is highly resistant to the multipass interference. One of the known methods to demodulate the OFDM signal that is modulated by the OFDM modulation is the scattered pilot scheme. This scheme uses, as an amplitude phase reference for demodulation, SP symbols scattered in the frequency and time axes.

The scattered pilot scheme is disclosed in, for example, Japanese Patent Laid-Open Publication Nos. 2000-22661 and 2005-45664, and European Patent Application Publication No. EP 1 408 665 A2.

The Japanese '661 publication discloses in its FIG. 1 an OFDM demodulation system, and particularly, an equalization process in the OFDM demodulation system that removes the propagation line distortion. It is disclosed that the equalization process uses the technology of an automatic equalizer that performs the inverse Fourier transform. The OFDM demodulation system receives a signal having a frame structure that includes a frame symbol, followed by a pattern signal for propagation line estimation, followed by a data symbol. The OFDM demodulation system uses the pattern signal for propagation line estimation to estimate the transfer function. The system then uses the estimated transfer function to equalize the data symbol.

The Japanese '664 publication shows in its FIG. 1 a carrier data equalizer of the OFDM signal and discloses the equalization technology. The carrier data equalizer includes an SP signal extraction means that extracts a scattered pilot signal from the carrier data of the OFDM signal, an inverse fast Fourier transform (IFFT) circuit that uses the extracted SP signal to calculate an impulse response of the transmission line, a fast Fourier transform (FFT) circuit that estimates the frequency response of the transmission line from the calculated impulse response of the transmission line, and a division circuit that divides the carrier data of the OFDM signal by the estimated frequency response of the transmission line and outputs equalized carrier data of the OFDM signal.

In the equalizer, the SP signal extraction means includes a first and a second extraction means, the first extraction means extracting the past four-symbol SP signals including the latest one-symbol SP signal, a second extraction means extracting only the latest one-symbol SP signal. Further, the IFFT circuit includes a first and a second IFFT circuit that use the SP signals extracted from the first and second extraction means to calculate the first and second impulse responses, respectively. The first and second IFFT circuits have their outputs to which low pass filters are connected, respectively. The FFT circuit is included in a combiner circuit. It is disclosed that the combiner circuit uses a second impulse response in a time period when the delay time of the multipath can be detected using only the latest one-symbol SP signal on the input of the circuit, whereas it uses a first impulse response, from the upper limit of that time period to the upper limit of a time period in which the delay time of the multipath can be detected using the past four-symbol SP signals including the latest one-symbol SP signal.

The European '665 publication shows in its FIG. 1 the circuit configuration of an ISDB-T transmitter/receiver. The ISDB-T transmitter/receiver includes an OFDM signal equalization system, the system including an equalization controller and an equalizer that operates in cooperative with the equalization controller. It is disclosed in its FIG. 4 that the equalization controller includes an SP detector that detects from the complex symbol SP detection information and four-symbol synchronous information. It is also disclosed in its FIG. 5 that the SP detector has a circuit configuration having a four-symbol delay circuit.

U.S. Patent Application Publication No. US2003/0185322 to Takahashi discloses a digital wireless receiver. The receiver includes a first equalizer that updates a tap coefficient according to a received signal and a received signal area determination result and equalizes the waveform of the received signal to output a decoded signal. A multiplier multiplies the received signal by a one-symbol-old tap coefficient updated by the first equalizer. The resultant signal is supplied to the input of the first equalizer. This may be equivalent to expecting a frequency offset that applies a rotation in a certain direction and compensating the carrier offset, thus corresponding to a wider range of frequency offset and providing a stable operation.

Japanese Patent Laid-Open Publication No. 78013/1994 discloses a quadrature amplitude modulation (QAM) data receiver. The receiver has an automatic equalizer. The receiver determines the coordinates of three signals in parallel: the coordinate of an output signal from the equalizer after the signal is passed through an amplifier, the coordinate of the output signal after the signal is passed through an attenuator, and the coordinate of the output signal. The receiver then calculates errors in the amplitude direction for each of the coordinate determination output signals and each of the coordinate determination input signals. A coordinate determination output signal is selected which provides a coordinate determination result having the smallest errors. The output signal is then input to a decoder, thus reducing data errors due to the rapid amplitude variation on the line.

The devices or systems disclosed by the prior art documents have, however, problems as follows. In the OFDM demodulation system taught by Japanese '661 publication, it is assumed to receive a signal having a frame structure. The system therefore cannot demodulate a signal, such as used in the ISDB-T system, having a data structure that includes SP symbols scattered in the data symbol.

The IFFT circuit in the OFDM signal receiver disclosed by Japanese '664 publication IFFT-transforms the past four-symbol SP signals including the latest one-symbol SP signal (see its paragraph 0015). The OFDM signal receivers simply passes, however, the signals through two low-pass filters (LPFs) after they are IFFT-transformed. The low-pass filters cannot remove noise components included in the area passing through the low-pass filters. In the OFDM signal receiver, therefore, as noise in the received signal increases, errors in the transmission line estimation result increase, thus degrading the receiving properties.

The European '665 publication discloses the OFDM signal equalization system that includes the four-symbol delay circuit. The OFDM signal equalization system does not use, however, the inverse Fourier transform, but relatively compares with the four-symbol-old SP symbol in the same subcarrier. It is thus impossible to know a change in the transfer function of the transmission line until an SP symbol appears on the same subcarrier at four symbols later. When, therefore, a change occurs in the transfer function of the transmission line within four symbols, it may often be difficult to correctly perform the equalization.

The U.S. patent application to Takahashi discloses the digital wireless receiver that multiplies the received signal by the one-symbol-old tap coefficient. The digital wireless receiver does not use, however, the inverse Fourier transform, and thence it may often be difficult to correctly perform the equalization.

The quadrature amplitude modulation data receiver taught by Japanese '013 publication determines the coordinates of three signals in parallel, and calculates errors in the amplitude direction for each of the coordinate determination output signals and each of the coordinate determination input signals. The receiver does not use, however, the inverse Fourier transform, and hence it may also often be difficult to correctly perform the equalization.

### SUMMARY OF THE INVENTION

It is therefore an object of the present invention to provide an equalizer and an equalization method therefor that demodulate a signal having a data structure that includes SP symbols scattered in a data symbol.

The present invention provides an equalizer comprising: a first extractor that extracts a plurality of scattered pilot symbols from an input signal; an inverse Fourier transform circuit that inversely Fourier-transforms the extracted scattered pilot symbols to calculate a complex gain of each of a plurality of paths; a second extractor that uses the calculated complex gain to extract signals of the paths; a Fourier transform circuit that Fourier-transforms the extracted signals of the paths; a multiplier that multiplies a complex conjugate signal of a transmission line estimation result in the path on which the Fourier-transform was made by the input signal and outputs a product, a coordinate threshold generator that multiplies the transmission line estimation result by the complex conjugate signal to generate power of a coordinate threshold; a window function circuit that multiplies, for the generated power, only a predetermined subcarrier by a coefficient of a window function to correct the power value; and a coordinate corrector that compares, for each subcarrier, the output product with the corrected power value and corrects an amplitude of a modulation coordinate.

Also in accordance with the present invention, an equalization method comprises the steps of: extracting a plurality of scattered pilot symbol from an input signal, and inversely Fourier-transforming the extracted scattered pilot symbols to calculate a complex gain of each of a plurality of path; using the calculated complex gain to extract signals of the paths; Fourier-transforming the extracted signals of the paths; multiplying a complex conjugate signal of a transmission line estimation result in the path on which the Fourier-transform was made by the input signal to calculate a resultant product; multiplying the transmission line estimation result by the complex conjugate signal to generate power of a coordinate threshold; multiplying, for the generated power, only a predetermined subcarrier by a coefficient of a window function to correct the power value; and comparing, for each subcarrier, the calculated product with the corrected power value to correct an amplitude of a modulation coordinate.

An equalizer and an equalization method therefor according to the present invention may demodulate a signal having a data structure that includes SP symbols scattered in a data symbol with small transmission line estimation errors and a small operation amount. Particularly, the amplitude errors in the transmission line estimation result due to the SP symbols not evenly disposed over the whole Fourier transform points may be corrected using a window function, thus correcting the amplitude errors of the subcarrier in an intended band, and reducing degradation of the receiving properties even for the OFDM using the primary modulation such as the QAM that has amplitude information.

### BRIEF DESCRIPTION OF THE DRAWINGS

The objects and features of the present invention will become more apparent from consideration of the following detailed description taken in conjunction with the accompanying drawings in which:

FIG. 1 is a schematic block diagram of the configuration of an equalizer according to an embodiment of the present invention;

FIG. 2 illustrates a relationship between an OFDM symbol and a subcarrier in the equalizer in FIG. 1;

FIG. 3A illustrates an example waveform on an input to the threshold comparator in FIG. 1;

FIG. 3B illustrates an example waveform on an output from the threshold comparator in FIG. 1;

FIGS. 4A and 4B illustrate a change in frequency response by a limitation of pass band in FIG. 1;

FIGS. 4C and 4D illustrate a change in time response by a limitation of pass band in FIG. 1;

FIG. 5 is a schematic diagram useful for understanding an example of amplitude correction in the window function circuit in FIG. 1;

FIG. 6 illustrates an example of coordinate of 16QAM in the coordinate corrector in FIG. 1;

FIG. 7 is a schematic block diagram of the configuration of an equalizer according to an alternative embodiment of the present invention;

FIG. 8 illustrates a relationship between a real part component and time in each complex gain in FIG. 7;

FIG. 9 is a schematic block diagram of the configuration of the substantial portion of a channel estimator in an equalizer according to an embodiment of the present invention; and

FIG. 10 is a schematic block diagram of the configuration of the substantial portion of a channel estimator in an equalizer according to an alternative embodiment of the present invention.

### DESCRIPTION OF THE PREFERRED EMBODIMENTS

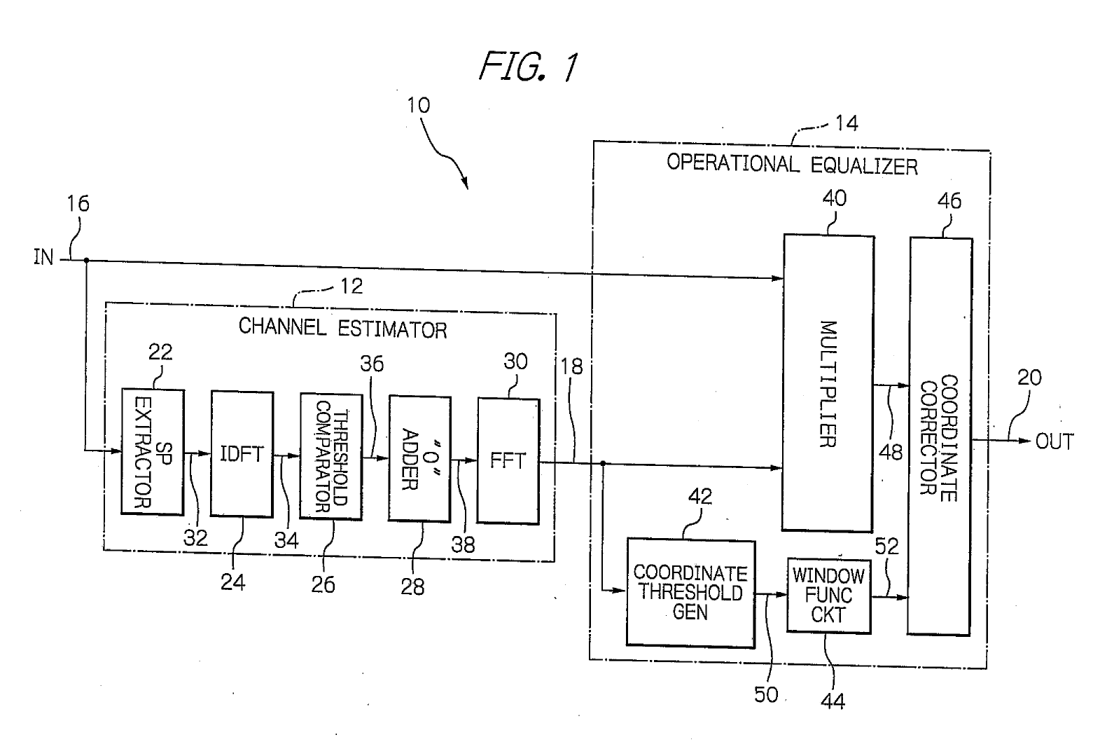

With reference to the accompanying drawings, embodiments of an equalizer according to the present invention will be described in more detail. Referring to FIG. 1, an equalizer 10 according to an embodiment of the present invention is generally configured such that a scattered pilot (SP) extractor 22 included in a channel estimator 12 extracts from an input signal 16 a plurality of SP symbols, which are in turn inversely Fourier-transformed by an inverse discrete Fourier transform (IDFT) circuit 24 to calculate a complex gain of each path, which is used by a threshold comparator 26 that is a second extractor and a “0” adder 28 to extract a plurality of paths, of which the signals are Fourier-transformed by a Fourier transform circuit 30 to produce signals of the extracted paths, on which a complex conjugate signal of a transmission line estimation result thus Fourier-transformed is multiplied with the input signal by a multiplier 40 included in an operational equalizer 14 to output a resultant product, and the transmission line estimation result is multiplied with the complex conjugate signal by a coordinate threshold generator to thereby generate power of a coordinate threshold, only a predetermined subcarrier being multiplied, for the generated power, with a coefficient of a window function by a window function circuit to thereby correct the power value, the corrected power value being compared, for each subcarrier, with the result from the multiplication by a coordinate corrector to correct the amplitude of the modulation coordinate. It is thus possible to demodulate a signal having a data structure that includes SP symbols scattered in a data symbol with smaller transmission line estimation errors and a small amount of operation.

Particularly with the illustrative embodiment, the amplitude errors in the transmission line estimation result due to SP symbols not evenly disposed over the whole Fourier transform points may be corrected using a window function, thus correcting the amplitude errors of the subcarrier in an intended band, and reducing degradation of the receiving properties even for the orthogonal frequency division multiplexing (OFDM) using the primary modulation such as the quadrature amplitude modulation (QAM) that has amplitude information.

In this illustrative embodiment, the present invention is implemented to as the equalizer 10. The illustration and description of portions not directly relevant to understanding the present invention will be omitted.

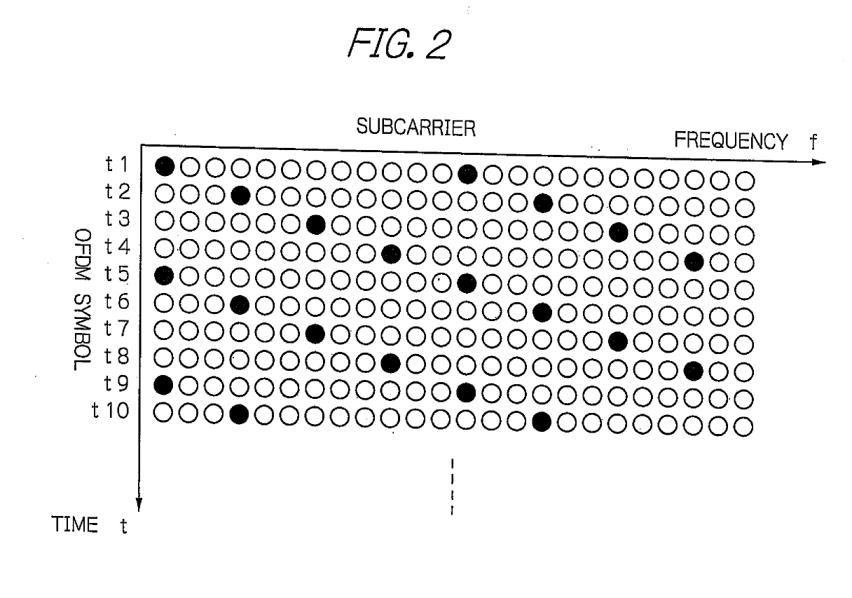

Referring continuously to FIG. 1, the equalizer 10 has a function of, for example, setting time t3 in FIG. 2 to the present time, and using an SP symbol in the present OFDM symbol to demodulate the present OFDM symbol. As seen from FIG. 1, the equalizer 10 includes the channel estimator 12 and the operational equalizer 14. The channel estimator 12 has a function of receiving the input signal 16 (IN) that is Fourier-transformed in units of one OFDM symbol and outputting a complex conjugate signal of a transmission line estimation result in the path on which the Fourier-transform was made. The input signal 16 is resultant from, for example, an output signal of a fast Fourier transform (FFT) circuit that demodulates the OFDM signal. The channel estimator 12 outputs an estimated complex conjugate signal 18 to the operational equalizer 14. The operational equalizer 14 has a function of receiving the input signal 16 and the complex conjugate signal 18, thus generating demodulation data 20 (OUT) through an equalization operation and outputting it.

As shown in FIG. 1, the channel estimator 12 includes the SP extractor 22, the inverse discrete Fourier transform (IDFT) circuit 24, the threshold comparator 26, the “0” adder 28, and the FFT circuit 30, which are interconnected as illustrated.

The SP extractor 22 has a function of extracting from the input signal a plurality of SP symbols. The SP extractor 22 extracts only the SP signal from the input signal 16 (IN), and complex-operates the extracted SP signal and a known SP. The SP extractor 22 outputs the complex operation results 32 to the IDFT circuit 24. In the following description, signals are designated with reference numerals of connecting lines on which they are conveyed.

The IDFT circuit 24 has a function of receiving the complex operation result i.e. the SP signal 32, and inversely Fourier-transforming the SP signal 32 to calculate a complex gain of each path. The IDFT circuit 24 uses the SP signal 32 to determine a complex gain 34 of a detectable delay time width. The IDFT circuit 24 then outputs the gain 34 to the threshold comparator 26. The IDFT circuit 24 may be adapted to use an inverse fast Fourier transform.

The threshold comparator 26 has a function of extracting, using the calculated complex gain, complex gains of a plurality of paths. The threshold comparator 26 extracts, from the inversely Fourier-transformed complex gain 34, a complex gain that provides a delay path having the maximum power. The threshold comparator 26 then uses the complex gain as a reference to set a relative threshold. The threshold comparator 26 has a function of comparing the set threshold with the complex gain of each path, transferring a complex gain equal to or more than the set threshold, and reducing a complex gain less than the threshold to “0”. The threshold comparator 26 outputs a complex gain 36 that is the comparison result to the “0” adder 28.

The “0” adder 28 has a function of adding “0” to the end of the complex gain of a detectable delay time width derived from the threshold comparison results, and generating a delay profile corresponding to one OFDM symbol length. The no adder 28 supplies the generated delay profile 38 to the FFT circuit 30.

The FFT circuit 30 has a function of fast Fourier-transforming the delay profile in the extracted path. The FFT circuit 30 receives the generated delay profile 38 and fast Fourier-transforms the latter. The FFT circuit 30 outputs the complex conjugate signal 18, which is the transformed transmission line estimation result, to the operational equalizer 14.

The operational equalizer 14 has a function of correcting errors due to the channel estimation by the channel estimator 12. This function is achieved by the operational equalizer 14 that includes the multiplier 40, a coordinate threshold generator 42, a window function circuit 44, and a coordinate corrector 46, which are interconnected as illustrated.

The channel estimation causes errors in the amplitude direction. In the phase modulation such as the quadriphase phase shift keying (QPSK), it is not necessary to correct such errors. In the amplitude modulation, such as the quadrature amplitude modulation (QAM), which includes modulation information in the amplitude component, the errors may be corrected to improve the receiving properties.

The multiplier 40 has a function of multiplying the complex conjugate signal 18 and the input signal 16 (IN), the signal 18 being the generated transmission line estimation result and the signal 16 being the output signal from the FFT that performs the OFDM demodulation. The multiplier 40 outputs the output signal 48 to the coordinate corrector 46.

The coordinate threshold generator 42 has a function of multiplying the transmission line estimation result generated in the FET circuit 30 from the delay profile and the complex conjugate signal of the result together, generating the power of the coordinate threshold. The coordinate threshold generator 42 outputs the generated power 50 of the coordinate threshold to the window function circuit 44.

The window function circuit 44 has a function of multiplying, for the power 50 determined in the coordinate threshold generator 42, only a predetermined subcarrier by a coefficient of a window function, thus correcting the power value. The window function circuit 44 outputs the corrected power value 52 to the coordinate corrector 46.

The coordinate corrector 46 has a function of comparing, for each subcarrier, the product 48 from the multiplier 40 and the power value 52 corrected in the window function circuit 44, thus correcting the amplitude of the modulation coordinate (constellation). The coordinate corrector 46 outputs the demodulation data 20 (OUT) derived from the correction of the amplitude of the modulation coordinate to a not-shown demodulation portion.

FIG. 2 shows a relationship between the OFDM symbol and the subcarrier in the equalizer 10 in FIG. 1. Referring to FIG. 2, a description will be given of the frame structure of an arrangement between the SP symbol and the data symbol in the SP scheme used in this embodiment. In FIG. 2, the y-axis is time t of the OFDM symbol, and x-axis is the frequency f of the subcarrier. In FIG. 2 the closed circle or black dot indicates an SP symbol, and the open circle or white dot indicates a data symbol.

In this embodiment, the same symbol arrangement appears every four OFDM symbols. Specifically, four frequencies are prepared of which SP symbols are inserted into the subcarrier, and different OFDM symbol by symbol. The same set of frequencies repeats every four OFDM symbols. It will be appreciated, however, that the invention is not limited to this cycle.

An equalization method in this embodiment will be described in more detail below. The equalizer 10, FIG. 1, receives the input signal 16 (IN), which is a mix of the SP symbols and the data symbols as shown in FIG. 2. The SP symbols are inserted into the subcarrier at four different sets of frequencies. A different set of frequencies is used for each OFDM symbol. The same set of frequencies repeats every four OFDM symbols.

The SP extractor 22 then uses the cycle of the input signal 16 from the outside to extract the SP symbol. The extraction may be specifically described as follows. The SP symbol is set as P, and the data symbol is set as D, for example. Assuming that the input signal 16 (IN) has a data array of DDDPDDDPDDDPDDD, the extraction is to replace D with zero. The extracted signal then has a data arrangement of 000P000P000P000.

After the SP symbol is thus extracted, the SP extractor 22 further complex-operates the phases of the extracted SP symbol and the known SP symbol. The SP extractor 22 then outputs the phase rotation undergone by the SP symbol in the transmission line and the amplitude to the IDFT circuit 24 as vectors. The phase rotation undergone by the SP symbol in the transmission line and the amplitude that are represented by vectors correspond to the transfer function and noise superimposed on the received SP symbol.

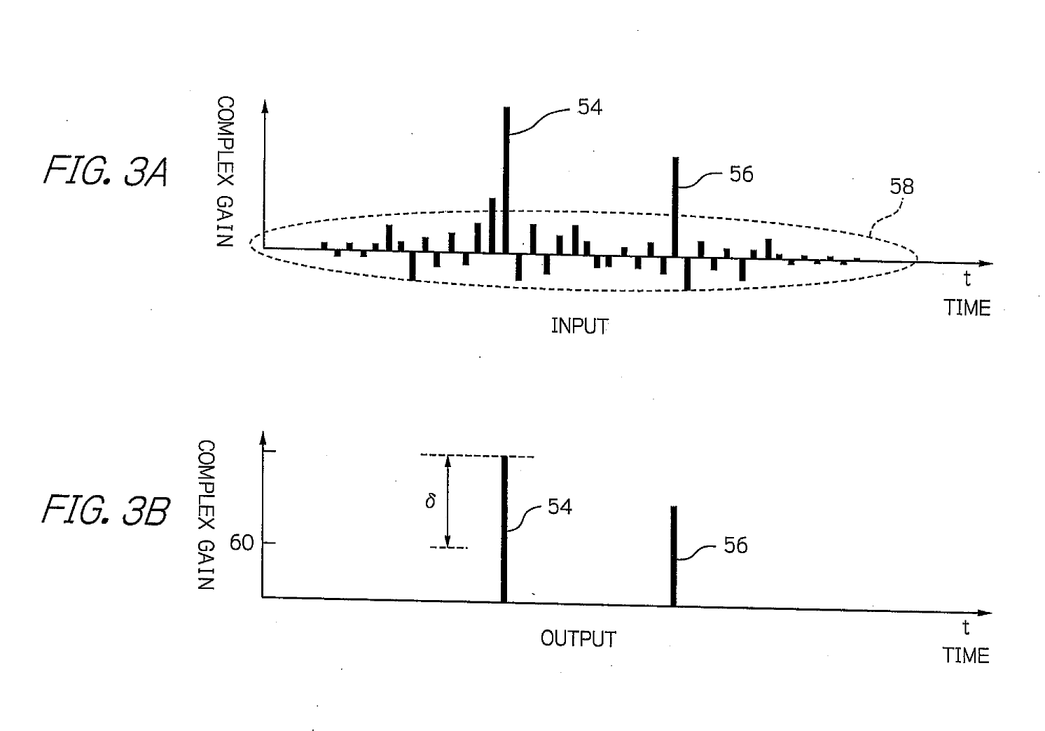

FIGS. 3A and 3B show input and output waveforms to and from the threshold comparison in FIG. 1. The IDFT circuit 24 receives the vectors of the phase rotation and the amplitude that are output from the SP extractor 22. The circuit 24 then performs an inverse discrete Fourier transform having a delay time width that may be estimated, thus determining the complex gain of the paths on which the signals arrive, as shown in FIG. 3A. The complex gain includes, in addition to the transfer function of the transmission line by the delay path, noise and operation errors.

In FIG. 3A, the signal 54 is of a path showing the maximum complex gain. The signal 54 may be estimated to directly arrive from the transmission device of the OFDM signal to the receiver. The signal 56 of the path may be estimated to be an OFDM signal that has reflected on, between the transmitter/receivers of the OFDM signal, an obstacle such as a building, thus traveling a longer path than the direct arrival signal. The signals 58 of the path indicated by a dotted line may be estimated to be caused by noise or operation errors.

In the instant illustrative embodiment, the IDFT circuit 24 uses, unlike the usual inverse discrete Fourier transform, different sine wave coefficients (e^{-jθ}) in the inverse discrete Fourier transform depending on the frequencies at which the SP symbols are inserted. The IDFT circuit 24 thus has a function of varying the sine wave coefficient (e^{-jθ}) for each OFDM symbol. The IDFT circuit 24 determines, using the following expression (1) of the inverse Fourier transform, the complex gain SP_res (t, l).

$$SP\_res ( t , 1 ) = {\sum }_{k = 0}^{sp\_num} SP\_sc ( t , k ) {e}^{j2π [ fsp 1 ( t ) + stp \times k ] \times l / fft\_num} \qquad ( 1 )$$

where the variable t is an OFDM symbol time, the variable l is a delay time, the variable k is an SP symbol number, the function SP_sc (t, l) shows a transfer function and noise superimposed on the SP symbol, the function fspl (t) shows a position of a subcarrier to the SP symbol having the lowest frequency, the variable stp is a subcarrier frequency interval of a SP symbol, the numerical value sp_num is the number of SP symbols used in the transmission line estimation, and the numerical value fft_num is the number of FFT points.

The IDFT circuit 24 performs the operation over a delay time width that may be estimated. The circuit 24 then outputs the operation result 34 to the threshold comparator 26.

Although the illustrative embodiment includes the IDFT circuit 24 as an example inverse discrete Fourier transform circuit, it will be appreciated that the embodiment may include an IFFT circuit in place of the IDFT circuit 24.

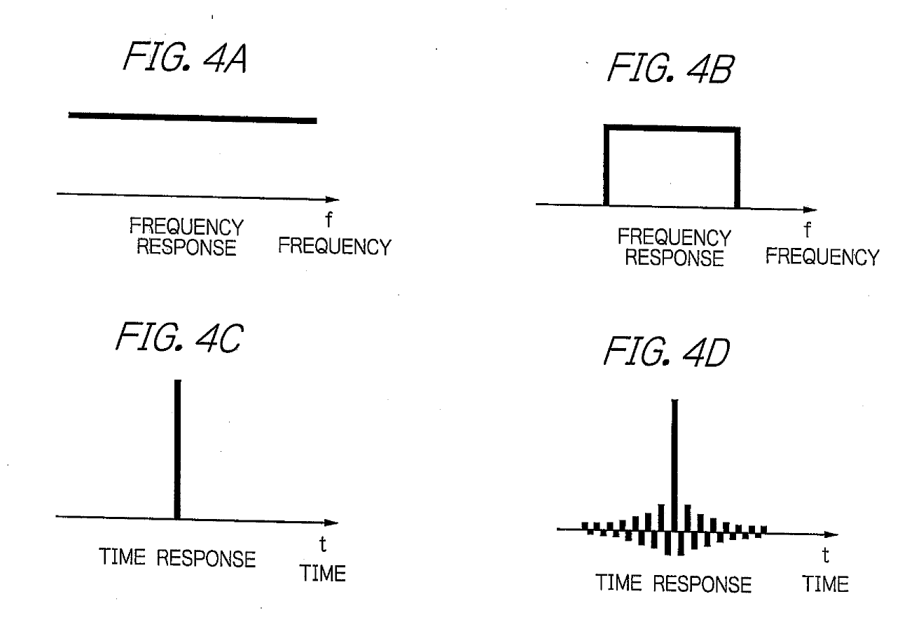

FIGS. 4A through 4D illustrate changes in a frequency response and a time response by a limitation of a pass band in FIG. 1. With reference to FIGS. 3A and 3B, and 4A through 4D, the operation of the threshold comparison circuit 26 will be described below. FIG. 3B shows the complex gain of the path extracted in the threshold comparator 26.

In the OFDM symbol having the SP symbols disposed at equal subcarrier intervals, the delay time width of the complex gain that may be theoretically estimated is, for the effective OFDM symbol length, up to the inverse of the subcarrier interval of the SP symbol.

The Integrated Services Digital Broadcasting Television (ISDB-T) includes, for example, one SP symbol for each set of 12 subcarriers. The delay time width of the complex gain that may be theoretically estimated is thus 1/12 of the effective OFDM symbol length. Specifically, in the threshold comparator 26, the compared complex gain is 1/12 of the total complex gain obtained by the inverse discrete Fourier transform.

The IDFT circuit 24 operates, using the inverse Fourier transform, the complex gain of the delay time width that may be estimated. The complex gain includes, in addition to the transfer function of the transmission line by the delay path, noise and operation errors. Noise is caused by the noise component involved in each received SP symbol. The operation errors occur because the SP symbols are not evenly disposed over the whole FFT points. In order to avoid aliasing generated in the OFDM demodulation, the usual OFDM modulation transmits signals at subcarriers fewer than the FFT points. This provides a time response similar to that for the transfer function having a limited pass band as shown in FIGS. 4C and 4D.

Because the band is limited in the receiver, the transfer function of the actual transmission line undergoes no band limitation. The accurate estimation of the transmission line thus requires the affect of the band limitation to be excluded. The output from the inverse Fourier transform in the IDFT circuit 24 includes the operation errors caused by the band limitation and noise superimposed on the SP symbol. It is preferable to remove noise and the operation errors.

In this embodiment, therefore, the threshold comparator 26 determines, from the complex gain obtained by the inverse Fourier transform in the IDFT circuit 24, power of the signals 54 and 56 of each path in FIG. 3A, and detects the signal 54 of the path having the maximum power of the determined power. The threshold comparator 26 then sets, as shown in FIG. 3B, a relative threshold 60 from the maximum power. The threshold comparator 26 extracts signals 54 and 56 of the path having power equal to or more than the threshold 60. The threshold comparator 26 determines, for example, the signals 54 and 56 of the path present within predetermined power amount δ from the maximum power.

The threshold comparator 26 then directly outputs the complex gains of the signals 54 and 56 of the extracted path. The comparator 26 also outputs zero for the signals 58 of the unextracted path. The threshold comparator 26 extracts, using the expression (2), the signals 54 and 56 of the path. The comparator 26 then outputs the threshold comparison result SP_ph (t), i.e. the complex gain 36 to the “0” adder 28. This may reduce affects from noise and the operation errors.

$$SP\_ph ( t , l ) = \{ \begin{matrix}SP\_res ( t , l ) & SP\_res {( t , l )}^{2} \cdot \geq α \times SP\_res {( t , {l}_{max} )}^{2} \\ 0 & SP\_res {( t , l )}^{2} \cdot < α \times SP\_res {( t , {l}_{max} )}^{2}\end{matrix} \qquad ( 2 )$$

where the variable lₘₐₓ is a delay time of a complex gain having the maximum power, the function SP_res (t, l) is a complex gain, and the coefficient α is a threshold operation coefficient and is less than one.

The “0” adder 28 adds a predetermined number of zeros to the threshold comparison result SP_ph (t) output from the threshold comparator 26. The “0” adder 28 then outputs the sum to the FFT circuit 30.

The delay time width of the complex gain that may be theoretically estimated is, for the effective OFDM symbol length, up to the inverse of the subcarrier interval of the SP symbol. The complex gain 36 has only that delay time width, when it is generated in the threshold comparator 26 after noise and the operation errors included therein are reduced. The FFT circuit 30 estimates the transmission lines for all subcarriers. It is therefore required to populate values in all FFT point numbers. It is thus necessary that “0” is added to time domains after the delay time width obtained by the threshold comparison and the sum is output to the FFT circuit 30 at the subsequent stage.

In other words, when a value having power is added to the time domains after the delay time width obtained by the threshold comparator 26, it will mean that the arrival path resides at a delay time corresponding to the time of the addition. The addition of “0” indicates that the delay time has no arrival paths, so the addition of “0” is important.

The FFT circuit 30 receives a value added with “0” by the “0” adder 28. The circuit 30 then fast Fourier-transforms the value to provide the transmission line estimation result. The FFT circuit 30 then outputs the transmission line estimation result 18 to the multiplier 40 and the coordinate threshold generator 42, both being in the operational equalizer 14.

The multiplier 40 complex-operates, according to the expression (3), the eq_d_raw (sub_c) and the conj{eq_corr (sub_c)}. The eq_d_raw (sub_c) is obtained for each subcarrier by fast Fourier-transforming the input signal 16 (IN), i.e. the received OFDM signal. The conj{eq_corr (sub_c)} is the complex conjugate signal of the transmission line estimation result generated in the delay profile FFT circuit 30. The multiplication may correct the phase rotation. The multiplication may not, however, correct the amplitude component.

The amplitude variation by the transfer function of the transmission line affects both of the output signal from the fast Fourier transform that performs the OFDM demodulation and the transmission line estimation result generated from the delay profile by the FFT circuit 30. The above two terms are multiplied by the expression (3). The product eq_d_vec (sub_c) is thus an output proportional to the square of the amplitude variation due to the transfer function of the transmission line.

eq_{—}d_{—}vec(sub_{—}c)=eq_{—}d_{—}raw(sub_{—}c)×conj{eq_{—}corr(sub_{—}c)} (3)

where the function eq_d_raw (sub_c) is the input signal IN and is the complex number data after the OFDM demodulation. The function eq_d_corr (sub_c) is correction information of the equalizer 10 and is the complex number data. The function eq_d_vec (sub_c) is the product in the expression (3) and is the complex number data after the OFDM demodulated phase correction.

Thus, the amplitude component of the product eq_d_vec (sub_c) is proportional to the square of the transfer function of the transmission line. The modulation method such as the QAM including information in the amplitude requires correction of the product. In this embodiment, therefore, the coordinate threshold generator 42 multiplies, according to the expression (4), the transmission line estimation result generated from the delay profile by the FFT circuit 30 and the complex conjugate thereof, thus providing a value proportional to the square of the transfer function of the transmission line. The coordinate threshold generator 42 then outputs the value to the window function circuit 44 as the comparison signal thresh_org (sub_c) of the coordinate correction at the subsequent stage.

thresh_{—}org(sub_{—}c)eq_{—}data_{—}gain(sub_{—}c)×eq_{—}corr(sub_{—}c)×conj{eq_{—}corr(sub_{—}c)} (4)

where the function thresh_org (sub_c) is the threshold reference value indicating the comparison signal of the coordinate correction and is a real number. The function eq_data_gain (sub_c) is the threshold gain for adjustment and is a real number.

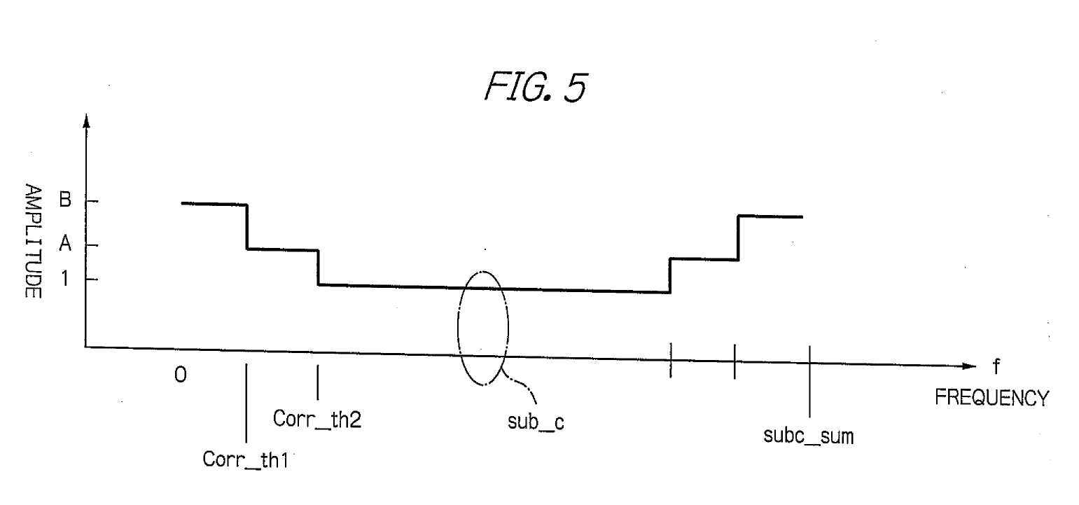

FIG. 5 shows the amplitude correction in the window function circuit 44 in FIG. 1. In FIG. 5, the x-axis represents frequency f. As discussed with respect to the threshold comparison, the operation errors in the transmission line estimation occur because the SP symbols are not evenly disposed over the whole FFT points. The subcarrier at the edge of the desired band has no adjacent SP symbols. Even after being processed in the comparing process, therefore, the subcarrier may have errors in the amplitude component. The errors become larger for the subcarrier nearer at the edge of the desired band.

The errors may be corrected by the window function circuit 44 in this embodiment. The circuit 44 positions to the subcarrier as shown in FIG. 5, and corrects the amplitude according to the expression (5) to output the correction result eq_thresh (sub_c) to the coordinate corrector 46.

$$eq\_thres ( sub\_c ) = \{ \begin{matrix}thresh\_org ( sub\_c ) \times B & 0 \leq sub\_c \leq corr\_th1 - 1 \\ thresh\_org ( sub\_c ) \times A & corr\_th1 \leq sub\_c \leq corr\_th2 - 1 \\ thresh\_org ( sub\_c ) \times 1 & corr\_th2 \leq sub\_c \leq subc\_sum - 1 - corr\_th2 \\ thresh\_org ( sub\_c ) \times A & subc\_sum - corr\_th2 \leq sub\_c \leq subc\_sum - 1 - corr\_th1 \\ thresh\_org ( sub\_c ) \times B & subc\_sum - corr\_th1 \leq sub\_c \leq subc\_sum - 1\end{matrix} \qquad ( 5 )$$

where the variable sub_c is the subcarrier number and the variable subc_sum subcarrier is the total number of subcarriers. The function eq_thresh (sub_c) is the output of the window function that is shown by the real number of the correction result. The values corr_th1 and corr_th2 are the correction adjustment subcarriers one and two.

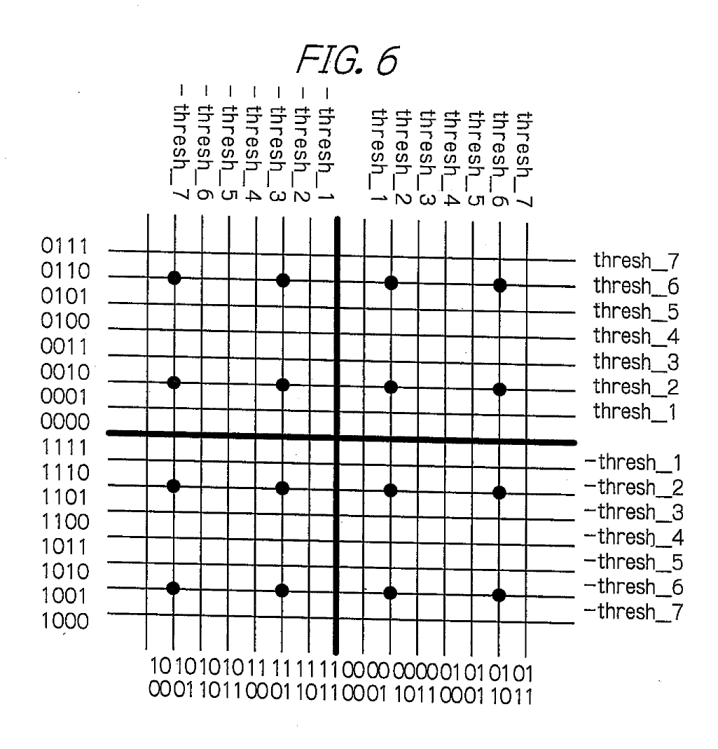

FIG. 6 shows an example coordinate of the 16QAM in the coordinate corrector 46 in FIG. 1. The coordinate corrector 46 corrects, with reference to the correction result eq_thresh (sub_c) by the window function circuit 44, the amplitude of the product eq_d_vec (sub_c), and outputs the demodulation data 20 (OUT). Although, mathematically, the division as “the product/the window function result” is performed, for the purposes of simplifying the division circuit, the thresholds one to seven (=hresh_{—}1 (sub_c) to thresh_{—}7 (sub_c)) as shown in the expression (6) are generated and the comparison results are set to the coordinate correction results.

When, for example, it is assumed that the coordinate correction output has a real number of four bits and an imaginary number of four bits, the threshold as the absolute value provides seven thresholds from the threshold one to the threshold seven. The amplitude information is generated by the comparison with the thresholds one to seven.

thresh_{—}1(sub_{—}c)=eq_{—}thresh(sub_{—}c)/4

thresh_{—}2(sub_{—}c)=eq_{—}thresh(sub_{—}c)/2

thresh_{—}3(sub_{—}c)=eq_{—}thresh(sub_{—}c)×3/4

thresh_{—}4(sub_{—}c)=eq_{—}thresh(sub_{—}c)

thresh_{—}5(sub_{—}c)=eq_{—}thresh(sub_{—}c)×5/4

thresh_{—}6(sub_{—}c)=eq_{—}thresh(sub_{—}c)×3/2

thresh_{—}7(sub_{—}c)=eq_{—}thresh(sub_{—}c)×7/4 (6)

where the values thresh_{—}1 (sub_c) to thresh_{—}7 (sub_c) are the thresholds one to seven.

The relationship between the thresholds one to seven and the constellation is depicted in FIG. 6. FIG. 6 shows an example coordinate of the 16QAM.

The instant illustrative embodiment provides the following five advantages.

(1) In this illustrative embodiment, the four OFDM symbols are used to estimate the transmission line. When, therefore, the transfer function of the transmission line in the four OFDM sections changes very little, it may be possible to provide more accurate equalization than when estimating the transmission line using one OFDM symbol.

(2) In this embodiment, the threshold comparison sets the threshold, deleting the complex gains having small power such as noise and the operation errors. The transmission line estimation errors are thus reduced and the receiving characteristics are improved with less noise.

(3) In this embodiment also, the threshold comparison sets the threshold according to the complex gain having the maximum power, deleting the complex gain having small power such as noise and the operation errors. The operation is thus not repeated unlike the conventional OFDM demodulation systems, and only one operation may accurately extract the complex gain for use in the estimation of the transmission line. Further, the repeat number may not be set in advance. Even when, therefore, there is a delay time position, for example, that provides a complex gain having power larger than the repeat number such as under the receiving environment where a large number of delay paths exist, it is possible to extract the complex gain of the delay time position for use in the accurate estimation of the transmission line. Under the receiving environment in which a large number of delay paths exist, the estimation scheme of the invention may easily provide better receiving properties than the conventional scheme of directly estimating the complex gain and the delay time of the transmission line.

(4) Further in this embodiment, one OFDM symbol is used to estimate the transmission line. The estimation scheme of this embodiment may thus follow the fast phasing or the like, which provides different transmission line characteristics for each OFDM symbol. The receiving characteristics are thus improved for the phasing.

(5) In this embodiment, when the SP symbols are not evenly disposed over the whole FFT points, the resultant amplitude errors in the transmission line estimation result are corrected by the window function. It is thus possible to correct the amplitude errors of the subcarriers in the desired band, reducing degradation of the receiving properties even for the OFDM using the primary modulation such as the QAM that has amplitude information.

Note that the equalizer and the equalization method of the present invention may cover the possibility of various circuit configurations in the channel estimator 12 provided at the input of the operational equalizer 14 in FIG. 1. The following embodiment may include an exemplified circuit configuration of the channel estimator, as will be described.

This alternative embodiment may be the same as the above embodiment except that the threshold comparator 26 extracts the path in a different way. In the above embodiment, the threshold comparator 26 extracts the path using power amount derived from the complex gain squared. In contrast, in this alternative embodiment, the threshold comparator 26 is adapted to extract the path using the absolute values of the real number and the imaginary number of the complex gain.

In this alternative embodiment, the threshold comparator 26 determines the absolute values of the real number and the imaginary number of the complex gain of each path obtained in the IDFT circuit 24, and then adds the absolute values of the real number and the imaginary number to each path signal, then extracting the signal of the path that has the complex gain having the maximum sum. The threshold comparator 26 also sets a relative threshold from the maximum sum and extracts the signal of the path having the sum equal to or more than the relative threshold. The threshold comparator 26 determines, for example, the signal of the path present within a predetermined value from the maximum sum. The threshold comparator 26 directly outputs the complex gain of the extracted path and outputs zero for the signal of the unextracted path. The threshold comparator 26 extracts, using the expression (7), the signals 54 and 56 of the paths, and outputs the threshold comparison result SP_ph (t) to the “0” addition circuit 28.

$$SP\_ph ( t , l ) = \{ \begin{matrix}SP\_res ( t , l ) & Re \{ SP\_res ( t , l ) \} + Im \{ SP\_res ( t , l ) \} \geq α \times [ Re \{ SP\_res ( t , {l}_{max} ) + Im \{ SP\_res ( t , {l}_{max} ) \} ] \\ 0 & Re \{ SP\_res ( t , l ) \} + Im \{ SP\_res ( t , l ) \} < α \times [ Re \{ SP\_res ( t , {l}_{max} ) + Im \{ SP\_res ( t , {l}_{max} ) \} ]\end{matrix} \qquad ( 7 )$$

This alternative embodiment may thus calculate power value of each path without the calculation of the square. In this alternative embodiment, thus, the equalizer 10 may be used even in the demodulation requiring a rapid processing.

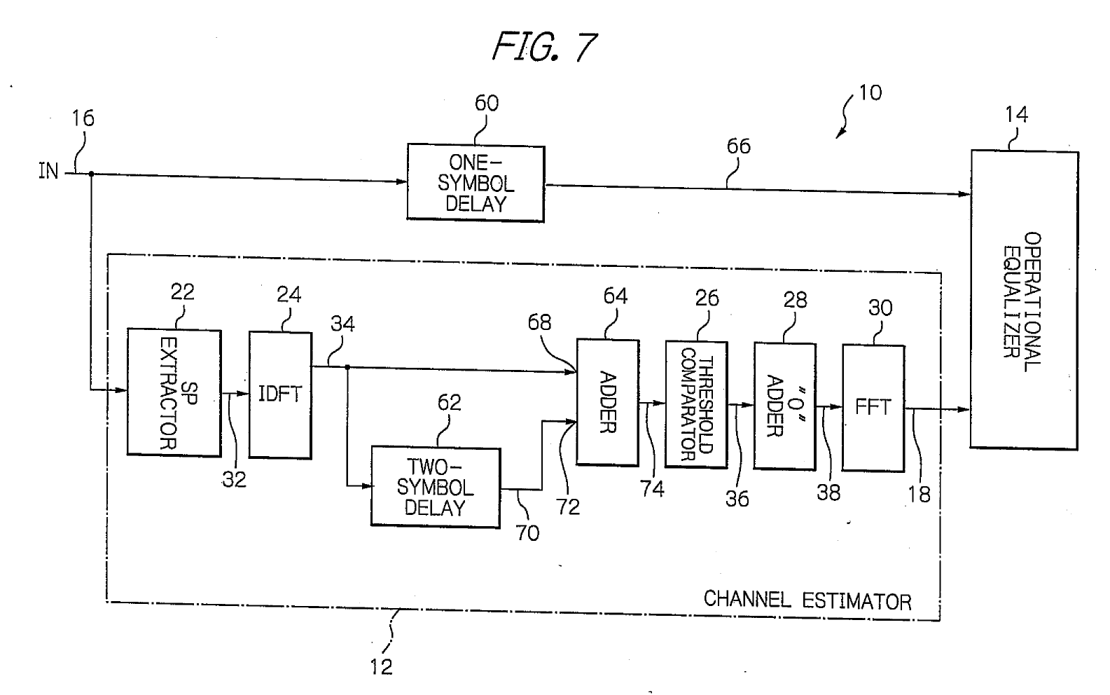

Well, FIG. 7 shows an equalizer 10 according to another alternative embodiment of the present invention. In this alternative embodiment, the components common to those in the above embodiment are provided with the same reference symbols.

In the instant alternative embodiment, the equalizer 10 is adapted to use, when time t3, FIG. 2, is set to the present, for example, the SP symbol in the OFDM symbol at time t3 and the SP symbol in the two-symbol-old OFDM symbol at time t1 to thereby demodulate the one-symbol-old OFDM symbol at time t2.

The equalizer 10 includes, in addition to the components in the above embodiment, a one-symbol delay circuit 60, a two-symbol delay circuit 62, and an adder 64. The one-symbol delay circuit 60 includes a random-access memory (RAM). The circuit 60 has a function of delaying the input signal IN by the time corresponding to one symbol. The one-symbol delay circuit 60 outputs the delayed input signal 16, as an input signal 66, to the operational equalizer 14.

As shown in FIG. 7, the channel estimator 12 includes, between the IDFT circuit 24 and the threshold comparator 26, the two-symbol delay circuit 62 and the adder 64. The IDFT circuit 24 supplies the operation result 34 to the two-symbol delay circuit 62 and one end 68 of the adder 64. The two-symbol delay circuit 62 includes, for example, an RAM. The circuit 62 delays the complex gain 34 output from the IDFT circuit 12 by the time corresponding to two symbols. The circuit 62 then supplies the delayed complex gain 70 to the other end 72 of the adder 64.

The adder 64 has a function of adding the complex gain 34 output from the IDFT circuit 24 to the complex gain 70 delayed in the two-symbol delay circuit 62. The adder 64 outputs the total value 74 to the threshold comparator 26. Using the two complex gains 34 and 70, the delay time width of the complex gain that may be theoretically estimated is ⅙ of the effective OFDM symbol length. The complex gain handled by the adder 64 is, therefore, ⅙ of the complex gain 34 output from the IDFT circuit 24 and ⅙ of the delayed complex gain 70 output from the two-symbol delay circuit 62.

It will be appreciated that when the two-symbol delay circuit 62 handles ⅙ of the complex gain 34, the adder 64 may handle the whole of the delayed complex gain output from the two-symbol delay circuit 62.

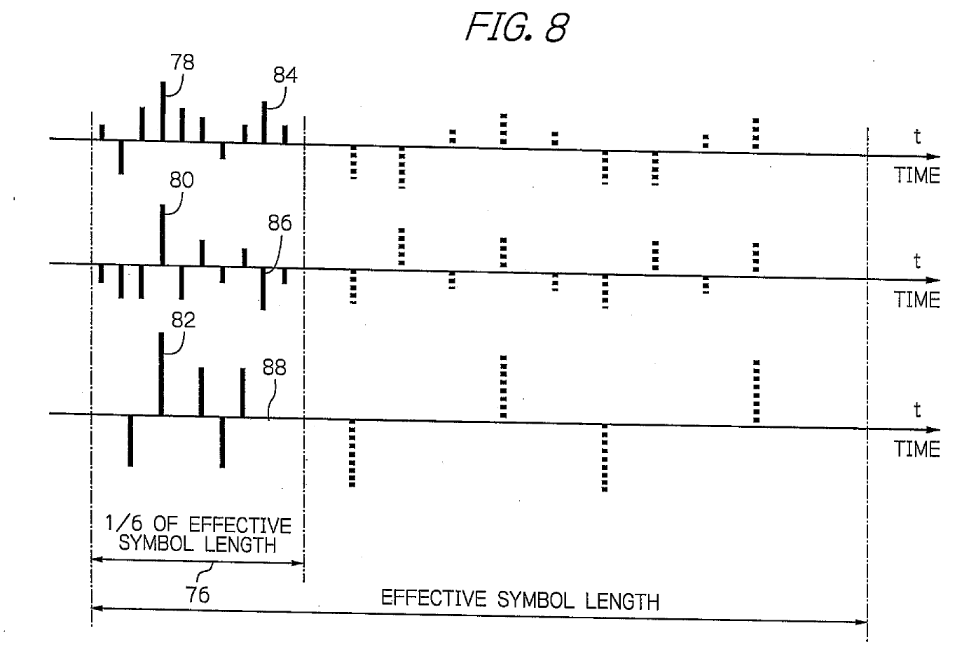

FIG. 8 shows the relationship between the real part component of each complex gain and the time in this alternative embodiment. The solid lines in FIG. 8 indicate the real part components within a range 76 of ⅙ of the effective OFDM symbol length. The broken lines indicate the real part components out of ⅙ of the effective OFDM symbol length. Specifically, the real part components represented by the broken lines are not to be operated by the adder 64. The operation of the adder 64 will be described below.

The adder 64 adds the complex gain 34 and the complex gain 70, thus canceling their components that are out of phase and leaving their components that are in phase. As seen from FIG. 8, when at the same time, for example, the two-symbol delay circuit 62 outputs a delayed complex gain 78 and the IDFT circuit 24 outputs a complex gain 80, the gains 78 and 80 being in phase, the adder 64 provides the sum of the two complex gains 78 and 80, i.e. a complex gain 82. When at the same time, the two-symbol delay circuit 62 outputs a delayed complex gain 84 and the IDFT circuit 24 outputs a complex gain 86, the gains 84 and 86 being out of phase, the adder 64 provides the difference between the two complex gains 84 and 86, i.e. a complex gain 88.

The operational equalizer 14 receives the signal 66 that is one-symbol delayed from the input signal 16 (IN) and the complex conjugate signal 18 output from the FFT circuit 30. The operational equalizer 14 performs the equalization operation, and corrects the amplitude errors in the transmission line estimation result using the window function and outputs the demodulation data 20 (OUT).

This alternative embodiment may have, in addition to advantages similar to those in the above embodiments, the following advantages (a) (b) and (c).

(a) In this alternative embodiment, two OFDM symbols are used to estimate the transmission line. Therefore, when the transfer function of the transmission line in the four OFDM sections changes very little, it may be possible to provide more accurate equalization than when estimating the transmission line using one OFDM symbol.

(b) In the present alternative embodiment, two OFDM symbols are used to estimate the transmission line. The subcarriers of the SP symbols may thus be disposed in a way equivalent to the six-subcarrier cycles. The time width of the arrival path in the transmission line that may be estimated is thus twice that of the arrival path obtained when estimating the transmission line using one symbol. The delay path providing a later arrival time may thus be equalized.

(c) In this alternative embodiment, the transmission line is estimated using the SP symbols included in two OFDM symbols, the two OFDM symbols being one symbol before and one symbol after the OFDM symbol in the transmission line equivalently corrected. If, therefore, the phasing changes the transfer function of the transmission line, for example, smaller errors may occur.

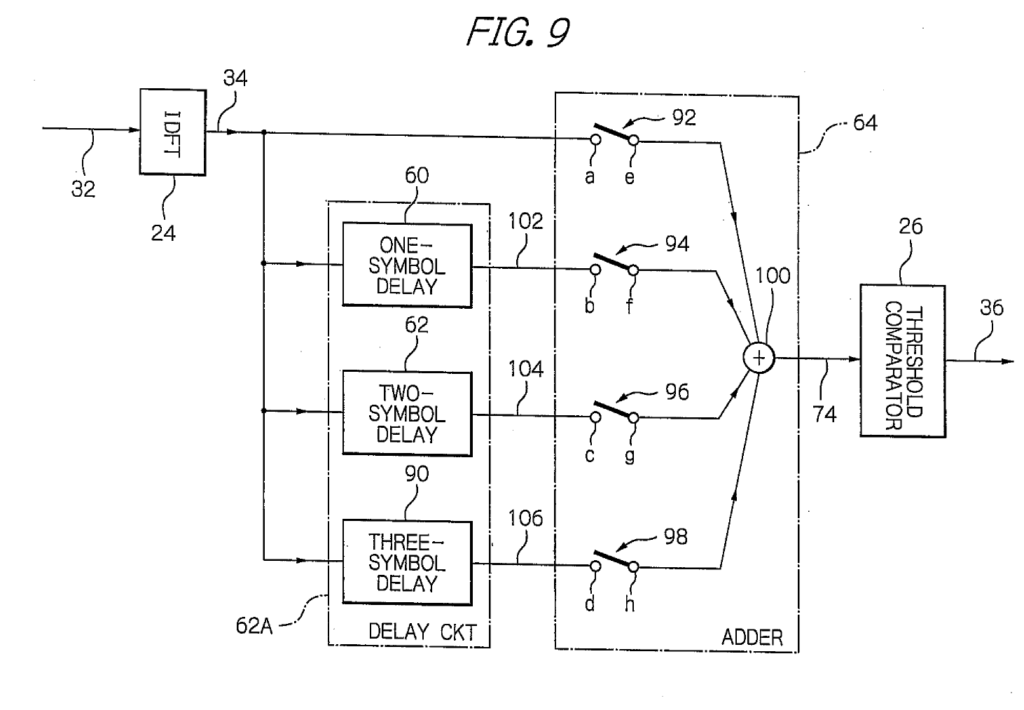

Now, FIG. 9 shows an alternative configuration of the substantial portion of the channel estimator 12 in the equalizer according to an alternative embodiment of the present invention. The channel estimator 12 includes the components shown in FIG. 9 in addition to those shown in FIG. 7. As shown in FIG. 9, the channel estimator 12 in this alternative embodiment includes a delay circuit 62A and an adder 64 between the IDFT circuit 24 and the threshold comparator 26.

In the instant alternative embodiment, the equalizer 10 is adapted to use, for example, the SP symbol in the OFDM symbol at time t5, FIG. 2, which is set to the present time, the SP symbol in the one-symbol-old OFDM symbol at time t4, the SP symbol in the two-symbol-old OFDM symbol at time t3, and the SP symbol in the three-symbol-old OFDM symbol at time t2, thus demodulating the one-symbol-old OFDM symbol at time t4.

The delay circuit 62A in the channel estimator 12 includes, as shown in FIG. 9, a one-symbol delay circuit 60, a two-symbol delay circuit 62, and a three-symbol delay circuit 90, which are interconnected as illustrated. The adder 64 includes selector switches 92, 94, 96, and 98, and an adder 100, which are interconnected also as illustrated.

The one-symbol delay circuit 60, the two-symbol delay circuit 62, and the three-symbol delay circuit 90 are supplied with the complex gain 34 from the IDFT circuit 24. The complex gain 34 is also supplied to the input terminal a of the selector switch 92. The one-symbol, two-symbol, and three-symbol delay circuits 60, 62, and 90 are implemented by RAMs. The delay circuits 60, 62, and 90 are adapted to delay the complex gain 34 to provide complex gains 102, 104, and 106 that correspond to one symbol, two symbols, and three symbols, respectively. The circuits 60, 62, and 90 then supply the complex gains 102, 104, and 106 to input terminals b, c, and d of the selector switches 94, 96, and 98, respectively.

The selector switches 92, 94, 96, and 98 in the adder 64 turn on or off in response to switching signals. The switches 92, 94, 96, and 98 thus output the complex gain 34 and the delayed complex gains 102, 104, and 106 from output terminals e, f, g, and h of the selector switches 92, 94, 96, and 98 to the adder 100, respectively. The adder 100 adds the complex gains 34, 102, 104, and 106 that are supplied when the selector switches 92, 94, 96, and 98 are on, thus providing the total value 74 of the complex gains and outputting it to the threshold comparator 26.

The operations of the delay circuit 62A and the adder 64 will briefly be described below. The delay circuit 62A delays the complex gain 34 to provide the complex gains 102, 104, and 106 that correspond to one symbol, two symbols, and three symbols, respectively, and outputs the gains to the adder 64. The adder 64 provides three on/off states of the selector switches: one state where only the selector switch 94 is conductive, another state where only the selector switches 92 and 96 are conductive, and the remaining state where the selector switches 92, 94, 96, and 98 are all conductive.

The state where only the selector switch 94 is on is similar to the state in the first embodiment. In this state, the SP symbol included in one OFDM symbol is only used to estimate the transmission line. In the state where only the selector switches 92 and 96 are on, as in the embodiment shown in and described with reference to FIG. 8, the SP symbols included in two OFDM symbols are only used to estimate the transmission line. In the state when the selector switches 92, 94, 96, and 98 are all on, only the SP symbols included in four OFDM symbols are used to estimate the transmission line.

In the state where the selector switches 92, 94, 96, and 98 are all on, the adder 64 adds four complex gains. Therefore, the delay time width of the complex gain that may be estimated is theoretically ⅓ of the effective OFDM symbol length. In the state where only the selector switches 92 and 96 are on, the delay time width is, as in the embodiment in FIG. 8, ⅙ of the effective OFDM symbol length. In the state where only the selector switch 94 is on, the delay time width is, as in the first embodiment, 1/12 of the effective OFDM symbol length. The threshold comparator 26 and the “0” adder 28 operate depending on the length, accordingly.

This alternative embodiment may have, in addition to advantages similar to those in the first embodiment, the following advantages (a) to (c).

(a) In this alternative embodiment, four OFDM symbols are used to estimate the transmission line. Therefore, when the transfer function of the transmission line changes very little, it may be possible to provide more accurate equalization than when estimating the transmission line using one OFDM symbol.

(b) In the instant alternative embodiment, the one OFDM symbol is used to estimate the transmission line. The subcarriers of the SP symbols may thus be disposed in a way equivalent to the three-subcarrier cycles. The time width of the arrival path in the transmission line that may be estimated is thus quadruple that of the arrival path obtained when estimating the transmission line using one symbol. The delay path providing a later arrival time may thus be equalized.

(c) In the present alternative embodiment, the transmission line is estimated using the SP symbols included in the OFDM symbol in the transmission line equivalently corrected, in two OFDM symbols that are one symbol before and after the first OFDM symbol, and in two OFDM symbols that are two symbols before and after the first OFDM symbol. If, therefore, the phasing or the like changes the transfer function of the transmission line, smaller errors may occur compared to when the transmission line is estimated using the SP symbols included in the four OFDM symbols: the OFDM symbol in the corrected transmission line, the OFDM symbol that is one symbol before the first OFDM symbol, the OFDM symbol that is two symbols before the first OFDM symbol, and the OFDM symbol that is three symbols before the first OFDM symbol.

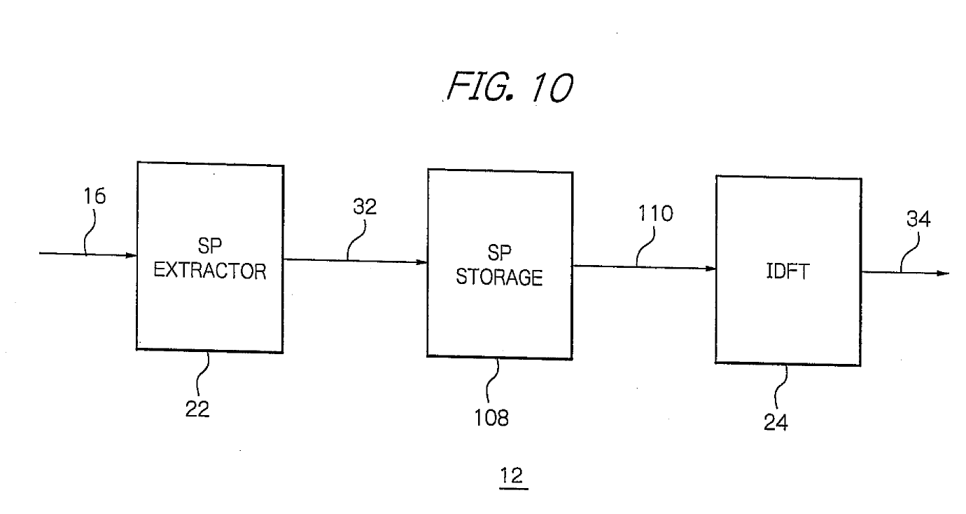

Well, reference will be made to FIG. 10 showing an alternative configuration of the substantial portion of the channel estimator 12 in the equalizer according an embodiment of the present invention. The channel estimator 12 includes the components in FIG. 10 in addition to those shown in FIG. 1. As depicted in FIG. 10, the channel estimator 12 in this alternative embodiment includes an SP storage 108 interconnected between the SP extractor 22 and the IDFT circuit 24. Although not specifically shown, the equalizer 10 includes the one-symbol delay circuit 60 shown in FIG. 7.

In this alternative embodiment, the equalizer 10 is adapted to use, when time t3, FIG. 2, is set to the present, the SP symbol in the OFDM symbol at time t3 and the SP symbol in the two-symbol-old OFDM symbol at time t1 to thereby demodulate the one-symbol-old OFDM symbol at time t2.

The SP storage 108 in the channel estimator 12 includes a RAM, for example. The SP storage 108 stores the SP symbol 32 output from the SP extractor 22. The SP storage 108 outputs the read SP symbol 110 to the IDFT circuit 24.

The operation of the SP storage 108 will be described below. The SP storage 108 stores the SP symbol extracted from the present OFDM symbol, the SP symbol extracted from the one-symbol-old OFDM symbol, the SP symbol extracted from the two-symbol-old OFDM symbol, and the SP symbol extracted from the three-symbol-old OFDM symbol. The SP storage 108 then outputs, in response to a not-shown control signal, the stored SP symbol 110 to the IDFT circuit 24. The SP symbol storage 108 may output the SP symbol for one symbol only. The SP storage 108 may instead output a combination of a plurality of symbols.

This alternative embodiment may have advantages similar to those in the first embodiment and in the embodiment shown in FIG. 9.

The present invention is not limited to the disclosed embodiments but may employ various uses and variants. Examples of uses and variants may include the following (A) and (B).

(A) The channel estimator 12 in the first embodiment shown in FIG. 1 may be changed to a circuit configuration other than that in the above embodiments.

(B) The operational equalizer 14 in the first embodiment shown in FIG. 1 may be modified to a circuit configuration other than that shown in FIG. 1.

The entire disclosure of Japanese patent application No. 2006-248605 filed on Sep. 13, 2006, including the specification, claims, accompanying drawings and abstract of the disclosure is incorporated herein by reference in its entirety.

While the present invention has been described with reference to the particular illustrative embodiments, it is not to be restricted by the embodiments. It is to be appreciated that those skilled in the art can change or modify the embodiments without departing from the scope and spirit of the present invention.

What is claimed is:

1. An equalizer comprising:
a first extractor that extracts a plurality of scattered pilot symbols from an input signal;
an inverse Fourier transform circuit that inversely Fourier-transforms the extracted scattered pilot symbols to calculate a complex gain of each of a plurality of paths;
a second extractor that uses the calculated complex gain to extract signals of the paths;
a Fourier transform circuit that Fourier-transforms the extracted signals of the paths;
a multiplier that multiplies a complex conjugate signal of a transmission line estimation result in the path on which the Fourier-transform was made by the input signal to output a resultant product,
a coordinate threshold generator that multiplies the transmission line estimation result by the complex conjugate signal to generate power of a coordinate threshold;
a window function circuit that multiplies, for the generated power, only a predetermined subcarrier by a coefficient of a window function to correct the power value; and
a coordinate corrector that compares, for each subcarrier, the output product with the corrected power value to correct an amplitude of a modulation coordinate.

2. The equalizer in accordance with claim 1, wherein said inverse Fourier transform circuit performs one of an inverse discrete Fourier transform and a inverse fast Fourier transform.

3. The equalizer in accordance with claim 1, wherein said second extractor comprises:
a threshold comparator that determines a maximum of power amount for each of the paths, and determines whether the power amount for each of the paths resides in a predetermined range from the maximum power amount to output the determination result; and
an addition circuit that adds a predetermined number of zeros to the output determination result to output a resultant sum.

4. The equalizer in accordance with claim 1, wherein said second extractor comprises:
a threshold comparator that adds absolute values of a real number and an imaginary number of the complex gain of each of the paths, determines a maximum value of the additions, and determines whether the absolute value for each of the paths resides in a predetermined range from the maximum value to output the determination result;
an addition circuit that adds a predetermined number of zeros to the determination result from said threshold comparator to output a resultant sum.

5. An equalization method comprising the steps of:
extracting a plurality of scattered pilot symbols from an input signal, and inversely Fourier-transforming the extracted scattered pilot symbols to calculate a complex gain of each of a plurality of paths;
using the calculated complex gain to extract signals of the paths;
Fourier-transforming the extracted signals of the paths;
multiplying a complex conjugate signal of a transmission line estimation result in the path on which the Fourier-transform was made by the input signal to calculate a resultant product;
multiplying the transmission line estimation result by the complex conjugate signal to generate power of a coordinate threshold;
multiplying, for the generated power, only a predetermined subcarrier by a coefficient of a window function to correct the power value; and
comparing, for each subcarrier, the calculated product with the corrected power value to correct an amplitude of a modulation coordinate.

6. The method in accordance with claim 5, wherein the inverse Fourier transform is an inverse discrete Fourier transform.

7. The method in accordance with claim 5, further comprising a step of determining a maximum of power amount for each of the paths, and selecting a path having power amount residing in predetermined range from the maximum power amount to output the selected plurality of the paths.

8. The method in accordance with claim 5, further comprising a step of adding absolute values of a real number and an imaginary number of the complex gain of each of the paths, determining a maximum value of the additions, and selecting a path having an absolute value within a predetermined range from the maximum value, and extracting the selected plurality of paths.
